(19) United States
(12) Patent Application Publication
(10) Pub. No.: US 2018/0171972 A1
(43) Pub. Date: Jun. 21, 2018

(54) SYSTEM AND METHOD FOR PREVENTING COLLISIONS BETWEEN WIND TURBINE BLADES AND FLYING OBJECTS

(71) Applicant: SINTEF Energi AS, Trondheim (NO)

(72) Inventors: Karl Otto MERZ, Trondheim (NO); John Olav Giæver TANDE, Trondheim (NO)

(21) Appl. No.: 15/580,528

(22) PCT Filed: Jun. 6, 2016
(86) PCT No.: PCT/NO2016/050116

§ 371 Date: Dec. 7, 2017

(30) Foreign Application Priority Data
Jun. 8, 2015 (NO) 20150740

(51) Int. Cl. F03D 7/00; G05B 13/02

(52) U.S. Cl. CPC F03D 7/00; G05B 13/026; F05B 2270/101; F05B 2270/404; F05B 2270/107; F05B 2270/8041; F05B 2220/706; F05B 2240/912; F05B 2270/805; F05B 2270/8042; F05B 2270/304

(57) ABSTRACT

A system and a method for control of a wind turbine for prevention of collisions between the rotor and flying objects such as birds, bats, and remotely-piloted aircraft is disclosed. The position and velocity of one or more flying objects is measured. The probability of the positions of the objects when they pass through the surface swept by the rotor blades is estimated. Increasing or decreasing the speed of the wind turbine rotor is performed such that the probability of collision between the rotor blades and the one or more objects is reduced or minimized, while otherwise continuing power production as usual.

### INTRODUCTION

The present invention concerns a method, a collision prevention control module, and a collision prevention control system for preventing collisions between flying objects, such as birds, bats, and remotely-piloted aircraft, and wind turbine blades, without significantly changing the operating state or decreasing the energy production of the wind turbines. The invention also concerns a wind turbine provided with a collision prevention control system.

### BACKGROUND

Wind turbines represent a hazard to birds and bats. A bird or bat hit by a wind turbine rotor blade will be killed, and the collision may also damage the rotor blade, which may result in stopping of the turbine and costly repairs of the blade. Other scenarios could be envisioned where a collision risk may exist between flying objects and wind turbine blades. For instance, remotely piloted drone aircraft have been proposed for inspection and maintenance of blades, implying that such aircraft will be active within wind farms. A malfunction or other event could cause the aircraft to deviate from the planned flight path. Similar remotely piloted aircraft are also flown for recreation by novices, who might not always have full control over the flight path.

There exist a number of solutions for preventing birds from hitting the wind turbine blades. U.S. Pat. No. 8,742,977 B1 detects birds in the vicinity of wind turbines and engages a deterrent, like intense lights or sounds, to scare the birds away. Similar patents, on detecting and repelling birds, are found in the field of aviation. Employed on a broad scale, such deterrents could have negative ecological impacts, driving away not only birds, but also other non-targeted animals living in the vicinity of wind turbines. There is also the danger of desensitization, where over repeated exposures the birds become accustomated to the deterrents, thereby negating the effect.

WO 2010/076500 A1 describes a method where flying objects in the vicinity of a single wind turbine are detected using one or more radar. Safety zones are defined, based upon the spherical volume surrounding and of the same diameter as the circular area swept by the rotor blades. (It is implied in the definition of the safety zones that the wind turbine is of a standard horizontal-axis type.) If an object is detected within the safety zones, the wind turbine is slowed or stopped, such that the blades no longer pose a collision threat. When the object leaves the safety zones, the wind turbine is returned to operation.

DE10 2005 046 860.8 describes a method where a region around a wind turbine is monitored for birds or bats, and, if a threshold number are detected, the wind turbine rotor is braked or stopped, to reduce the danger of collision.

These existing methods thus involve changing the operating state of the wind turbine, from a normal operating state to one in which the rotor speed is reduced, in order to reduce the danger of collision. Reduced rotor speed results in curtailment of power production, and thus loss of revenue.

### SUMMARY OF THE INVENTION

The present invention is conceived to solve or at least alleviate the problem of collisions mentioned above, while maintaining production of the wind turbine.

The present invention provides a method, a collision prevention control module, and collision prevention control system of actively regulating the rotational speed of a wind turbine in order to avoid collisions between the wind turbine rotor blades and flying objects such as birds, bats, or remotely-piloted aircraft.

The invention provides a method of controlling a wind turbine having at least one rotor blade, avoiding collision between at least one flying object and the at least one rotor blade. The method comprises controlling a rotational speed of the wind turbine rotor based on at least one measured position and at least one measured velocity of the at least one flying object.

The method may further comprise predicting a probability distribution of at least one flight path of the at least one flying object from the at least one measured position and the at least one measured velocity of the at least one flying object. A probability of collision between the at least one flying object and the at least one rotor blade, and a perturbation of the rotational speed of the wind turbine rotor may further be estimated in order to avoid collision between the at least one flying object and the at least one rotor blade. The probability of collision may be estimated based on an estimated intersection between the probability distribution of the at least one flight path with a swept surface of the at least one rotor blade as a function of position and time. Measuring the at least one position and the at least one velocity of the at least one flying object may be performed at a number of times t providing a number of updated measurements. For each of the number of updated measurements a perturbation of the rotational speed of the wind turbine rotor may be estimated in order to avoid collision.

The invention further provides a collision prevention control module for a wind turbine, the collision prevention control module being adapted for controlling a speed of the wind turbine rotor based on a measured position and a measured velocity of the at least one flying object avoiding collision between the at least one rotor blade and the at least one flying object.

The collision prevention control module may further be adapted for predicting a probability distribution of at least one flight path of the at least one flying object from the measured position and the measured velocity of the at least one flying object. Further, the collision prevention control module may be adapted for calculating a speed perturbation of the wind turbine rotor to avoid collision with the at least one flying object. The collision prevention control module may further be adapted for outputting the calculated speed perturbation to a speed error function of a control module of the wind turbine. An interface communicating with a generator converter of the wind turbine may also be provided.

The invention further provides a wind mill comprising a collision prevention control module for controlling a speed of a wind turbine rotor based on a measured position and a measured velocity of the at least one flying object avoiding collision between at least one rotor blade and the at least one flying object.

The collision prevention control module may be provided with features as described above. The wind turbine may further comprise at least one sensor for measuring the position and measuring the velocity of the at least one flying object.

The invention further provides a collision prevention system for a wind turbine, the collision prevention system comprising at least one sensor for measuring a position and measuring a velocity of the at least one flying object; and a collision prevention control module controlling a speed of a rotor of the wind turbine based on a measured position and a measured velocity of the at least one flying object avoiding collision between at least one wind turbine rotor blade and the at least one flying object.

In an embodiment, the at least one sensor may further comprise at least one of a sensor arranged at a cone of the wind turbine, a sensor arranged on a housing of the wind turbine, a sensor arranged on a tower of the wind turbine; and a sensor arranged on the ground. The at least one sensor may be an active sensor. The at least one active sensor may be a radar or a lidar, preferably an ultra wide-band radar. The at least one sensor may be a passive sensor. The at least one passive sensor may be at least one of a visual sensor or a thermal imaging camera.

The present invention does not involve a deterrent, nor does it involve slowing or stopping the wind turbine to a degree that would make a collision less dangerous and result in loss of power production and revenue.

Rather, the wind turbine benignly increases or decreases its rotational speed by a small amount, which is small enough that energy production is not meaningfully affected, such that it is improbable that the blades and flying objects are located in the same place at the same time. This provides a more environmentally friendly green energy harvesting system with increased safety for birds and bats, at the same time as the energy production is maintained, and costly repairs of the wind turbine blades avoided.

### BRIEF DESCRIPTION OF DRAWINGS

Embodiments of the invention will now be described with reference to the following drawings, where:

FIG. 1 illustrates the surface swept by the rotor blades of a wind turbine according to an embodiment of the invention;

FIG. 2 illustrates a wind turbine with sensors according to an embodiment of the invention;

FIG. 3 illustrates a strategy to alter a rotational speed of the rotor according to an embodiment of the invention;

FIG. 4 illustrates a control system for controlling a rotational speed of the rotor according to an embodiment of the invention; and

FIG. 5 illustrates a collision prevention control module according to an embodiment of the invention.

### DETAILED DESCRIPTION

The present invention will be described with reference to the drawings. The same reference numerals are used for the same or similar features in all the drawings and throughout the description.

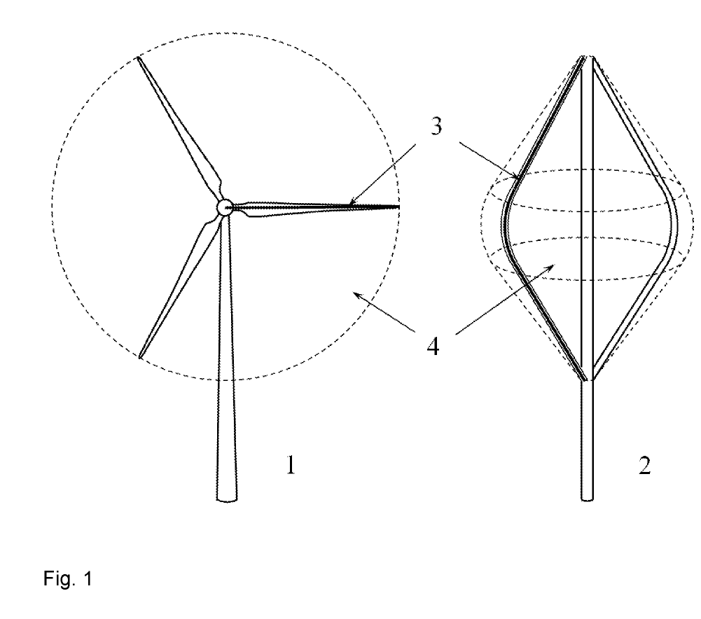

A horizontal-axis wind turbine 1 and a vertical-axis wind turbine 2 for energy harvesting are illustrated in FIG. 1. In each type of wind turbine, the profile 3 of the blades can be described by a theoretical line or curve (illustrated with dotted lines in FIG. 1). The curve is most likely contained within the airfoil profile at each spanwise location along the blade, but might also be located outside the airfoil profile. This curve, when swept 360 degrees about the axis of rotation, defines a swept surface 4 associated with the rotor blades of the wind turbine. Multiple curves might be defined, resulting in a family of swept surfaces; the present invention applies to any number of swept surfaces, or other similar regions of space associated with the blade trajectory, although for clarity the examples illustrate the case of one swept surface. The wind turbine may have at least one rotor blade.

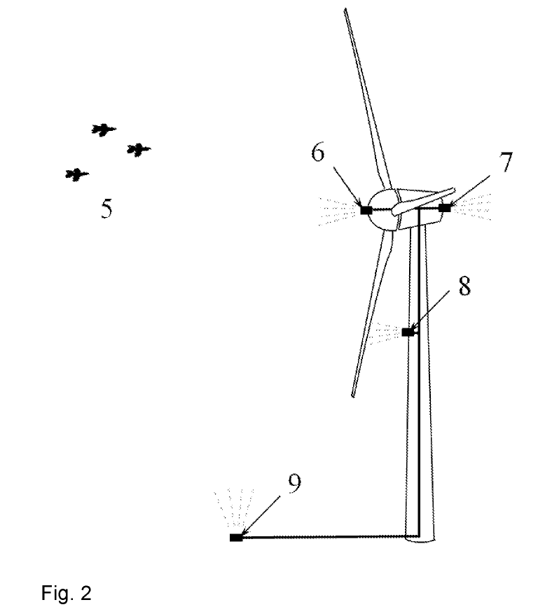

Taking the example of a horizontal-axis wind turbine, FIG. 2 shows one or more objects 5, in this example birds, flying towards the wind turbine rotor swept surface 4. The objects may in principle approach from any direction, although the present invention is less likely to be effective in the event that the objects approach the swept surface on its tangent (parallel to the surface).

The wind turbine in FIG. 2 is provided with one or more active, e.g. radar, lidar, or passive, e.g. visual or thermal imaging camera, sensors. These sensors may be provided on or near the wind turbines or wind farms. In FIG. 2 there is a sensor 6 at the cone of the wind turbine, a sensor on the wind turbine housing 7, a sensor on the tower 8 of the wind turbine and a sensor on the ground 9. A number of sensors may be arranged in other positions.

Modern wind turbines operate with a variable and controllable rotational speed. The invention is based on the concept that if the paths of one or more flying objects approaching the rotor swept surface were known a sufficient time in advance, then a small perturbation (increase or decrease) could be made to the rotational speed, such that the probability of collision between the blades and the flying objects was reduced or minimized, while otherwise continuing power production as usual. Likewise, if the paths of the flying objects deviated according to some manoeuvre; and yet the position and velocity of the objects were periodically updated by measurements, then a series of such small perturbations could be made to the rotational speed of the wind turbine rotor, such that the estimated probability of collision between the blades and the flying objects was periodically reduced or minimized, while otherwise continuing power production as usual. In addition, if the possible deviations in the flight paths were characterized mathematically by a probability function, then the probability of the location of the flying objects at some future time could be computed. In particular, the intersection could be taken between the possible trajectories of each flying object, according to this probability function, and the swept surface, giving the probability, as a function of position and time, of when and where the objects may cross the swept surface. Thereby, one or more small perturbations could be made to the rotational speed of the wind turbine rotor, such that the estimated probability of collision between the blades and the flying objects was periodically reduced or minimized according to the chosen probability function, while otherwise continuing power production as usual.

Although the above example refers to one probability function, the present invention is also applicable in the case where more than one probability function is employed.

The invention thus provides a method of controlling a wind turbine avoiding collision between at least one flying object and at least one rotor blade of the wind turbine. The rotational speed of the wind turbine is actively controlled based on a measured position and a measured velocity of a flying object. A probability distribution of at least one of the possible flight paths may be predicted for the flying object from the measured position and the measured velocity. The measured velocity includes both a speed and a direction of the flying object at a time t. A probability of collision between the flying object and the rotor blade(s) may further be estimated. A perturbation of the rotational speed of the wind turbine rotor may be estimated in order to avoid collision between the flying object and the rotor blade(s). The probability of collision may be estimated based on an estimated intersection between the probability distribution of the flight path with a swept surface of the rotor blade(s) as a function of position and time. The measurement of the position and the velocity of the flying object may be performed a number of times t providing a number of updated measurements. For each of the number of updated measurements a perturbation of the rotational speed of the wind turbine rotor is estimated in order to avoid collision.

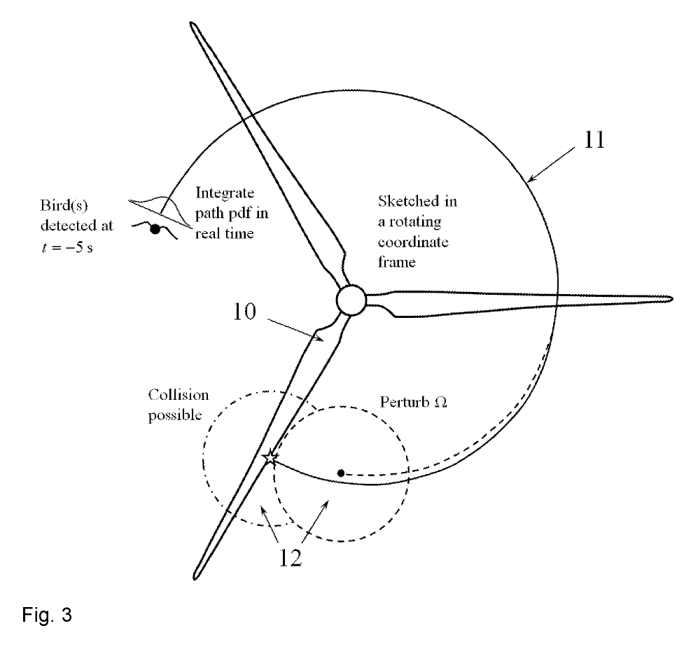

A simplified example of the working of the invention is shown in FIG. 3. The figure is drawn in the rotating coordinate frame, that is, following the rotor 10. A straight path towards the rotor plane in a ground-based frame appears as a spiral 11 in the rotating frame. A bird is detected at some time, for example t=−5 s, before passing through the rotor plane. The bird position and velocity (speed and direction) at the time t=−5 s is detected. The probability distribution of the path of the bird in space is integrated in real time, establishing a region 12 representing the probability distribution of the flight path of the bird when passing the swept surface by the rotor blades. Control measures for controlling the rotational speed Ω of the rotor, perturbing the speed by some Δω_{b}<<Ω, so as to avoid collision with the bird, may then be performed. In the rotating coordinate frame, this moves the region 12 away from the positions of the rotor blades and towards the gaps between the blades, as shown in FIG. 3. The illustrated region of probability of the flight path of the bird when passing the swept surface is highly simplified for purposes of describing the basic concept. In reality the region of probability may have a complicated shape with many contours of differing degrees of probability, and the resulting region after perturbing the rotor speed may still have regions of nonzero probability which intersect the blade locations, representing a reduced but nonzero probability of collision.

The invention assumes the ability to detect and predict the probability distribution p(x_{br}) of the flight paths of objects far enough ahead of time that a small correction to the rotational speed of the rotor is sufficient to provide an effective reduction in the probability of collision. For modern utility-scale electricity-generating wind turbines, the relevant time interval is expected to be on the order of several seconds. The invention is in principle independent of the time interval between detection of the objects and when they cross the swept surface, but the invention is more likely to be effective the longer the time interval.

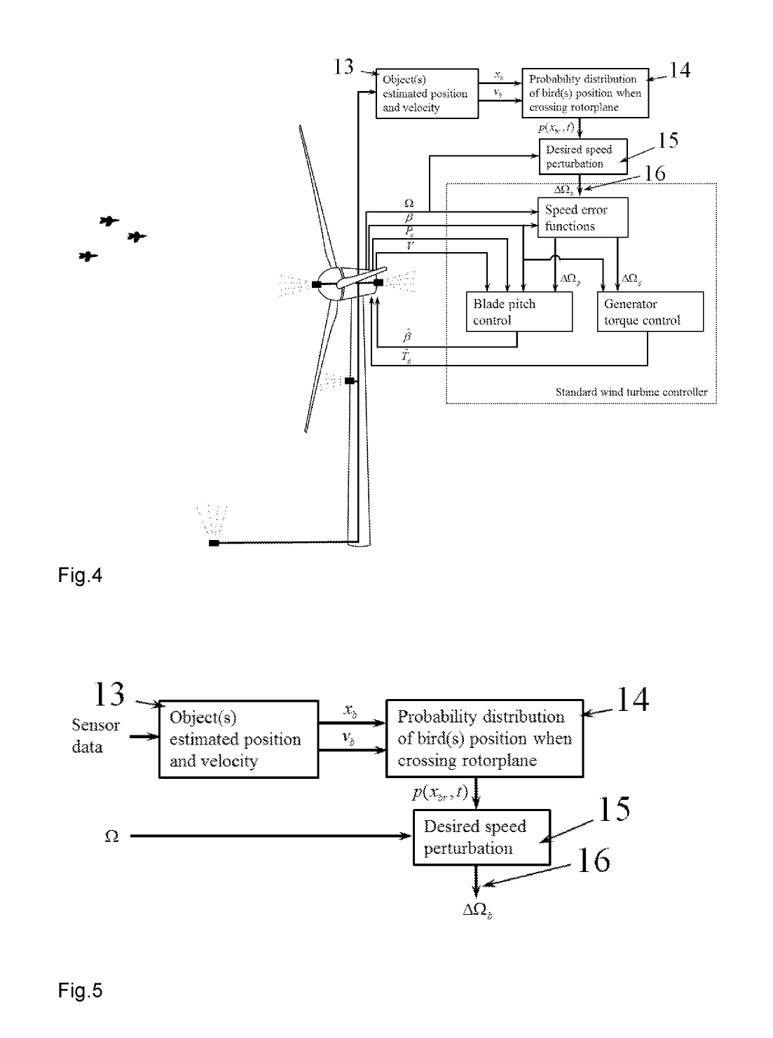

An embodiment of the invention is shown in FIG. 4. A block diagram illustrates a standard wind turbine controller, together with a system implementing the present invention.

The standard controller accepts as inputs at least the measured speed Ω of the wind turbine rotor, and usually also the blade pitch angle β of the wind turbine rotor blades, the electrical power Pₑ being generated, and the windspeed at the nacelle V. The standard controller outputs a desired blade pitch angle and generator torque T_{g}, with these desired outputs denoted in the figure with hats over the variable names. Separate controllers (not shown) associated with the blade pitch actuators and the electrical system provide the desired blade pitch angle and generator torque on a fairly rapid timescale.

Within the standard wind turbine controller, the speed error functions output some effective speed errors ΔΩₚ to the blade pitch control block, and ΔΩ_{g} to the generator torque control block. These speed errors are used to obtain the desired blade pitch angle and generator torque outputs.

This version of a standard wind turbine controller has been described in order to illustrate how the present invention can be implemented on many existing commercial wind turbines. However, the present invention is independent of the particular design of the standard wind turbine controller. It is also possible to incorporate the present invention as either an add-on or an integral part of any wind turbine control system.

FIG. 4 illustrates the horizontal-axis wind turbine 1 from FIG. 2 provided with the same sensors as described for FIG. 2.

In the embodiment of the invention shown in FIG. 4, the standard wind turbine controller is provided with an additional control module for collision prevention. The object positions x_{b} and velocities v_{b}, measured by the sensors, are input into the anti-collision control module. The anti-collision control module uses the measured position and velocity to predict the probability distribution p(x_{b},t) of the flight paths of birds, from which a probability distribution p(x_{br},t) of the birds' position when crossing the swept surface 4 may then be estimated. The probability distribution p(x_{br},t) is used in calculating a desired speed perturbation ΔΩ_{b} which is in this case an additional input to the speed error functions of the standard wind turbine controller, acting along with the measured speed Ω to determine the output ΔΩₚ and ΔΩ_{g}. Thereby the anti-collision control module influences, in the necessary manner, the blade pitch, generator torque, and resulting rotor speed at future times.

The control module for collision prevention comprising a number of modules as illustrated in FIG. 5.
An input module 13 for receiving the sensor measurement data and estimating object positions x_{b} and velocities v_{b}.
A prediction module 14 for predicting a probability distribution of at least one flight path of the at least one flying object from the measured position and the measured velocity of the at least one flying object.
A speed calculation module 15 for calculating a speed perturbation of the rotor to avoid collision with the at least one flying object.
A means of data transfer 16 for outputting the calculated speed perturbation to a speed error function of a control module of the wind turbine.

The collision prevention control module may together with sensor(s) for measuring a position and measuring a velocity of the flying object provide a collision prevention system for a wind turbine.

Globally, some 5-10,000 new wind turbines are installed every year, and most existing wind turbines are of a variable-speed type, which could be retrofit with the present invention. The modification of the control system can likely be prepared as an add-on to existing hardware, with an interface to the speed controller at the generator side converter of the wind turbine. The sensor technology can in principle be adapted from technologies which are available on the commercial market, and which are for instance used to track birds and bats in the field.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. A method of controlling a wind turbine avoiding collision between at least one flying object and at least one wind turbine rotor blade, the method comprising controlling a rotational speed of the wind turbine rotor based on at least one measured position and at least one measured velocity of the at least one flying object.

2. Method according to claim 1, further comprising:
predicting a probability distribution of at least one flight path of the at least one flying object from the at least one measured position and the at least one measured velocity of the at least one flying object.

3. Method according to claim 1, further comprising:
estimating a probability of collision between the at least one flying object and the at least one rotor blade.

4. Method according to claim 1, further comprising:
estimating a perturbation of the rotational speed of the wind turbine rotor in order to avoid collision between the at least one flying object and the at least one rotor blade.

5. Method according to claim 3, wherein the probability of collision is estimated based on an estimated intersection between the probability distribution of the at least one flight path with a swept surface of the at least one rotor blade as a function of position and time.

6. Method according to claim 1, further comprising:
measuring the at least one position and the at least one velocity of the at least one flying object at a number of times t providing a number of updated measurements.

7. Method according to claim 6, further comprising:
for each of the number of updated measurements estimating a perturbation of the rotational speed of the wind turbine rotor in order to avoid collision.

8. A collision prevention control module for a wind turbine, the collision prevention control module being adapted for controlling a speed of at least one rotor of the wind turbine based on a measured position and a measured velocity of at least one flying object avoiding collision between at least one wind turbine rotor blade and the at least one flying object.

9. The control module according to claim 8, further being adapted for predicting a probability distribution of at least one flight path of the at least one flying object from the measured position and the measured velocity of the at least one flying object.

10. The control module according to claim 8, further being adapted for calculating a speed perturbation of the wind turbine rotor to avoid collision with the at least one flying object.

11. The control module according to claim 8, further being adapted for outputting the calculated speed perturbation to a speed error function of a control module of the wind turbine.

12. The control module according to claim 8, further comprising:
an interface communicating with a generator converter of the wind turbine.

13. Wind turbine comprising:
a collision prevention control module for controlling a speed of a wind turbine rotor based on a measured position and a measured velocity of the at least one flying object avoiding collision between at least one rotor blade of the wind turbine and the at least one flying object.

14. Wind turbine according to claim 13, wherein the collision prevention control module is adapted for predicting a probability distribution of at least one flight path of the at least one flying object from the measured position and the measured velocity of the at least one flying object.

15. Wind turbine according to claim 13, further comprising at least one sensor for measuring the position and measuring the velocity of the at least one flying object.

16. A collision prevention system for a wind turbine, the collision prevention system comprising:
at least one sensor for measuring a position and measuring a velocity of at least one flying object; and
a collision prevention control module controlling a speed of at least one rotor of the wind turbine based on a measured position and a measured velocity of the at least one flying object avoiding collision between at least one rotor blade of the wind turbine and the at least one flying object.

17. The collision prevention system according to claim 16, wherein the at least one sensor further comprising at least one of:
a sensor arranged at a cone of the wind turbine,
a sensor arranged on a housing of the wind turbine,
a sensor arranged on a tower of the wind turbine; and
a sensor arranged on the ground.

18. The collision prevention system according to claim 16, wherein the at least one sensor is an active sensor.

19. The collision prevention system according to claim 18, wherein the at least one active sensor is a radar or a lidar, but preferably an ultra wide-band radar.

20. The collision prevention system according to claim 16, wherein the at least one sensor is a passive sensor.

21. The collision prevention system according to claim 20, wherein the at least one passive sensor is at least one of a visual sensor or a thermal imaging camera.

22. The collision prevention system according to claim 16, wherein the at least one flying object is at least one of a bird, bat, or remotely-piloted aircraft.

23. The method according to claim 1, wherein the at least one flying object is at least one of a bird, bat, or remotely-piloted aircraft.

24. The collision prevention control module according to claim 8, wherein the at least one flying object is at least one of a bird, bat, or remotely-piloted aircraft.

25. The wind turbine according to claim 13, wherein the at least one flying object is at least one of a bird, bat, or remotely-piloted aircraft.
